(19) United States
(12) Patent Application Publication
(10) Pub. No.: US 2006/0290264 A1
(43) Pub. Date: Dec. 28, 2006

(54) Image display device

(76) Inventors: Masataka Tsunemi, Isesaki-shi (JP); Hirotaka Murata, Fukaya-shi (JP); Hiroaki Ibuki, Fujisawa-shi (JP); Yuuji Haraguchi, Hiratsuka-shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 11/512,386

(22) Filed: Aug. 30, 2006

Related U.S. Application Data
(63) Continuation of application No. PCT/JP05/05930, filed on Mar. 29, 2005.

(30) Foreign Application Priority Data
Apr. 2, 2004 (JP) 2004-110118

(51) Int. Cl. H01J 63/04

(52) U.S. Cl. 313/495; 313/491

(57) ABSTRACT

A front substrate, which is included in an image display device, has a metal back layer which is laid over a phosphor screen and is composed of a plurality of insular divisional electrodes. The divisional electrode is composed of at least two row segments extending in a row direction X, and column segments which extend in a column direction Y and connect end portions of the row segments.

### CROSS-REFERENCE TO RELATED APPLICATIONS

This is a Continuation Application of PCT Application No. PCT/JP2005/005930, filed Mar. 29, 2005, which was published under PCT Article 21(2) in Japanese.

This application is based upon and claims the benefit of priority from prior Japanese Patent Application No. 2004-110118, filed Apr. 2, 2004, the entire contents of which are incorporated herein by reference.

### BACKGROUND OF THE INVENTION

1. Field of the Invention

The present invention relates to an image display device, and more particularly to a discharge damage suppression technique for an image display device using electron emitter elements.

2. Description of the Related Art

In recent years, a flat-screen image display device, in which a great number of electron emitter elements are arranged and disposed to be opposed to an image display surface, has been developed as a next-generation image display device. There are various types of electron emitter elements. Basically, any type of electron emitter element makes use of electron emission by an electric field. An image display device using the electron emitter elements is generally called “field emission display (FED)”. Of FEDs, an image display device using surface-conduction-type electron emitter elements is called “surface-conduction electron-emitter display (SED)”. In the present specification, the term “FED” is used as a general term including SEDs.

The FED generally includes a front substrate and a back substrate which are disposed to be opposed to each other with a predetermined gap. Peripheral parts of these substrates are attached to each other via a rectangular-frame-shaped side wall. Thereby, a vacuum envelope is constituted. The inside of the vacuum envelope is kept at a high vacuum level of about 10⁻⁴ Pa or less. In addition, a plurality of support members are provided between the back substrate and the front substrate in order to support an atmospheric-pressure load acting on these substrates.

A phosphor screen including phosphor layers, which emit red, blue and green lights, is formed on the inner surface of the front substrate. In order to obtain practical display characteristics, an aluminum thin film, which is called “metal back layer”, is formed on the phosphor screen.

A great number of electron emitter elements, which emit electrons for exciting the phosphor layers to emit light, are provided on the inner surface of the back substrate. In addition, a great number of scan lines and signal lines are formed in a matrix and connected to the respective electron emitter elements.

In this FED, an anode voltage is applied to the image display surface including the phosphor screen and the metal back layer. Electron beams, which are emitted from the electron emitter elements, are accelerated by the anode voltage and caused to strike the phosphor layers. Thereby, the phosphor layers emit light. Thus, an image is displayed on the image display surface. In this case, the anode voltage should be set at least at several kV, and more preferably at 10 kV or more.

However, the gap between the front substrate and back substrate cannot excessively be increased, from the standpoint of characteristics of resolution and spacers. The gap needs to be set at about 1 to 2 mm. Thus, in the FED, it is inevitable that an intense electric field is produced in a small gap between the front substrate and back substrate, and discharge between both substrates becomes a problem.

If no measure is taken to suppress discharge damage, a discharge occurs and causes damage or degradation to the electron emitter elements and thin-film electrodes connected thereto, as well as to the phosphor surface, driver ICs, driving circuits, etc. Such damage or degradation is generally referred to as discharge damage. In the situation in which such damage occurs, in order to put the FED to practical use, it is necessary to ensure that a discharge will never occur during a long period. It is very difficult to realize this, however.

It is thus important to take a measure to suppress discharge current to such a low level that discharge damage may not occur or may be ignorable even if electric discharge occurs in a rare case. A technique for this is disclosed, wherein notches are formed in a metal back that is provided on a phosphor surface and, for example, a zigzag pattern is formed, thereby to increase an effective impedance of the phosphor surface (see, e.g. Jpn. Pat. Appln. KOKAI Publication No. 2000-311642). In addition, a technique is disclosed, wherein a metal back is divided, and the divided parts of the metal back are connected to a common electrode via a resistor member, thereby applying a high voltage (see, e.g. Jpn. Pat. Appln. KOKAI Publication No. 10-326583). Furthermore, a technique has been disclosed, wherein a coating of an electrically conductive material is provided on divided parts of a metal back, thereby to suppress a surface creeping discharge at the divided parts (see, e.g. Jpn. Pat. Appln. KOKAI Publication No. 2000-251797). Besides, a technique is disclosed, wherein a metal back is divided or patterned, and a resistive material is used for the metal back (see, e.g. Jpn. Pat. Appln. KOKAI Publication No. 2003-242911).

By these prior-art techniques, however, it is difficult to sufficiently suppress discharge damage to the image display surface and electron emitter elements. With the technique of Patent Document 3 wherein a coating of an electrically conductive material is provided to suppress a surface creeping discharge between the divided parts, it is not expectable to obtain a sufficient performance because of restrictions to materials. To form an additional layer is not desirable from the standpoint of cost, mass-productivity and damage to the metal back. Under the circumstances, there has been a demand for a technique for suppressing a voltage occurring at the divided parts, without executing a resistance control at the divided parts.

### BRIEF SUMMARY OF THE INVENTION

The present invention has been made in consideration of the above-described problems, and the object of the invention is to provide an image display device which has a high discharge damage suppression performance and can improve display performance and reliability.

According to an aspect of the invention, there is provided an image display device including a front substrate having a phosphor screen which includes a phosphor layer and a light-blocking layer, and a metal back layer which is laid over the phosphor screen and is composed of a plurality of insular divisional electrodes; and a back substrate which is disposed to be opposed to the front substrate and is provided with electron emitter elements which emit electrons toward the phosphor screen, wherein the divisional electrode is composed of at least two row segments extending in a row direction, and column segments which extend in a column direction and connect end portions of the row segments.

### BRIEF DESCRIPTION OF THE SEVERAL VIEWS OF THE DRAWING

FIG. 1 is a perspective view that schematically shows an example of an image display device according to an embodiment of the present invention;

FIG. 2 is a cross-sectional view taken along line A-A in FIG. 1, and schematically shows a cross-sectional structure of the image display device;

FIG. 3 is a plan view that schematically shows the structure of a front substrate of an image display device according to a first embodiment of the invention;

FIG. 4 is a cross-sectional view that schematically shows the structure of the front substrate shown in FIG. 3;

FIG. 5 is a plan view that schematically shows the structure of a front substrate of an image display device according to a second embodiment of the invention; and

FIG. 6 is a plan view that schematically shows the structure of a front substrate of an image display device according to a third embodiment of the invention.

### DETAILED DESCRIPTION OF THE INVENTION

An image display device according to an embodiment of the present invention will now be described with reference to the accompanying drawings. An FED having surface-conduction electron emitter elements is described as an example of the image display device.

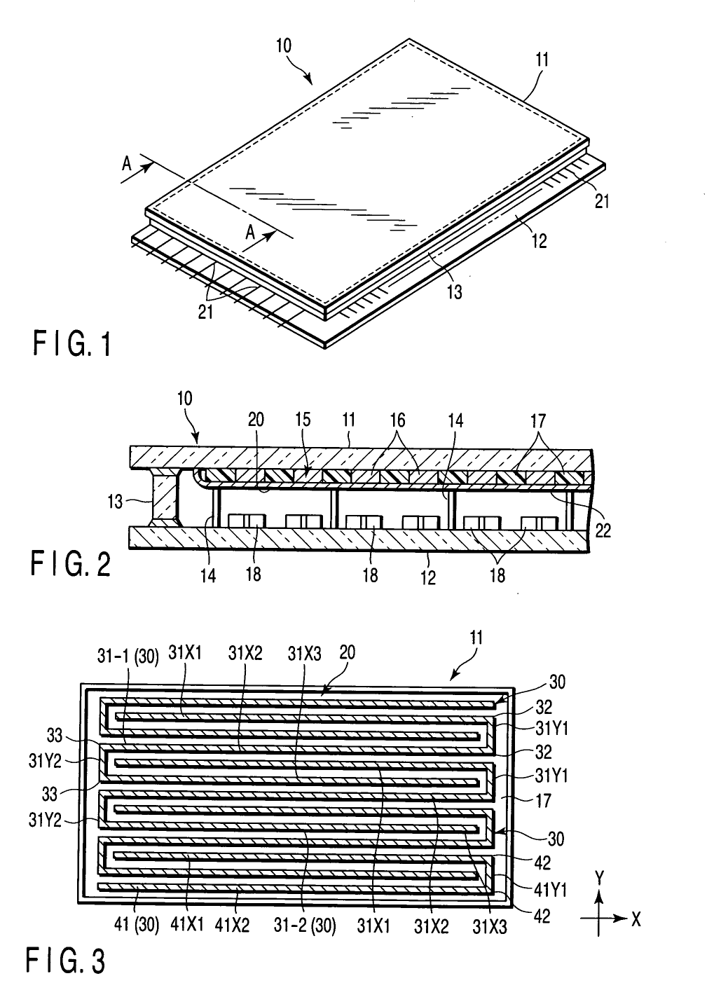

As is shown in FIG. 1 and FIG. 2, the FED includes a front substrate 11 and a back substrate 12, which are disposed to be opposed to each other with a gap of 1 to 2 mm. Each of the front substrate 11 and back substrate 12 is formed of a rectangular glass plate with a thickness of 1 to 3 mm. Peripheral edge parts of the front substrate 11 and back substrate 12 are attached via a rectangular-frame-shaped side wall 13, thereby forming a flat, rectangular vacuum envelope 10 in which a high-level vacuum of 10⁻⁴ Pa or less is maintained.

A plurality of spacers 14, which support an atmospheric pressure load acting on the front substrate 11 and back substrate 12, are provided within the vacuum envelope 10. The spacers 14 may be plate-like ones or columnar ones.

The front substrate 11 has an image display surface on its inside. Specifically, the image display surface is composed of a phosphor screen 15, a metal back layer 20 that is disposed on the phosphor screen 15, and a getter layer 22 which is disposed on the metal back layer 20.

The phosphor screen 15 is composed of phosphor layers 16, which emit red, green and blue lights, and a light-blocking layer 17 which is disposed in a matrix shape. The metal back layer 20 is formed of, e.g. aluminum, and functions as an anode. The getter layer 22 is formed of a metal film with gas adsorption properties, and adsorbs a gas remaining within the vacuum envelope 10 and an emission gas from the substrates.

The back substrate 12 has surface-conduction electron emitter elements 18 on its inner surface. The electron emitter elements 18 function as electron emitter sources which emit electron beams for exciting the phosphor layers 16 of the phosphor screen 15. Specifically, these electron emitter elements 18 are arranged on the back substrate 12 in columns and rows in association with pixels, and emit electron beams toward the phosphor layers 16. Each of the electron emitter elements 18 comprises an electron emission part and a pair of element electrodes for applying a voltage to the electron emission part, which are not shown. A great number of wiring lines 21 for supplying potential to the electron emitter elements 18 are provided in a matrix on the inner surface of the back substrate 12, and end portions of the wiring lines 21 are led out of the vacuum envelope 10.

In the FED, at the time of the operation for displaying an image, an anode voltage is applied to the image display surface including the phosphor screen 15 and the metal back layer 20. The electron beams, which are emitted from the electron emitter elements 18, are accelerated by the anode voltage and caused to strike the phosphor screen 15. Thereby, the phosphor layers 16 of the phosphor screen 15 are excited and caused to emit lights of associated colors. Thus, a color image is displayed on the image display surface.

Next, a detailed structure of the metal back layer 20 in the FED having the above-described structure is described. The term “metal back layer”, in this context, refers to not only a layer of a metal, but also layers of various materials. For the purpose of convenience, the term “metal back layer” is used.

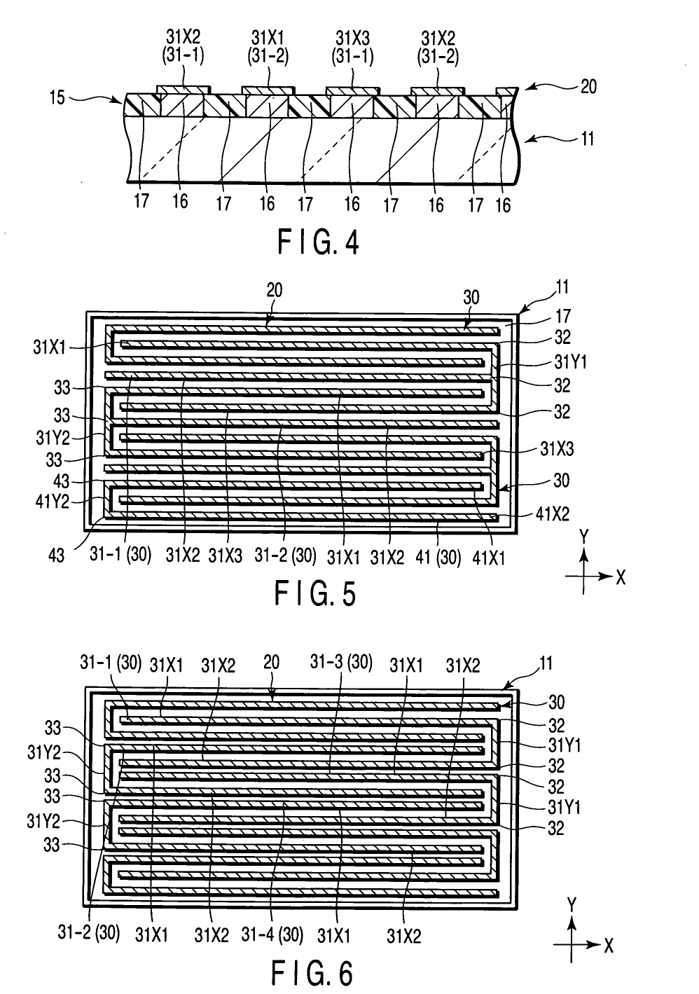

As is shown in FIG. 3 and FIG. 4, the phosphor screen 15 includes a great number of phosphor layers 16 which emit red, blue and green lights. These phosphor layers 16 extend in a row direction (longitudinal direction) X and are arranged in parallel with predetermined gaps in a column direction (transverse direction) Y. In addition, the phosphor screen 15 includes a great number of black light-blocking layers 17. The black light-blocking layers 17, like the phosphor layers 16, extend in the row direction X and are disposed between the phosphor layers 16.

The metal back layer 20, which is superposed on the phosphor screen 15, is composed of a plurality of insular divisional electrodes 30. The divisional electrodes 30 are mainly arranged on the phosphor layer 16 and are formed in stripe shapes in association with the phosphor layers 16. With this arrangement, the metal back layer 20 is always present on the phosphor layers 16, and does not affect the luminance characteristics and degradation of the phosphors.

In an example of the method for dividing the metal back layer 20, when the metal back layer 20 is to be formed on the phosphor screen 15, members with such characteristics as to electrically divide a thin film are disposed on the black light-blocking layers 17 in advance. Thereby, the metal back layer 20 is formed and divided at the same time. This method is effective, for example, in the case of forming the metal back layer 20 by a vacuum evaporation process. In another method for dividing the metal back layer 20, a metal back layer 20 in a non-divided form is formed, and then the metal back layer 20 is divided by heat treatment using, e.g. a laser, or by applying physical pressure.

In a first embodiment of the invention, each of the divisional electrodes 30 comprises at least two row segments extending in the row direction X, and column segments which extend in the column direction Y and connect end portions of these row segments.

Attention is now paid to a first divisional electrode 31-1 shown in FIG. 3. The first divisional electrode 31-1 has an S-shaped pattern in which one-side end portions 32 of a first row segment 31X1 and a second row segment 31X2 are connected by a first column segment 31Y1, and the other-side end portions 33 of the second row segment 31X2 and a third row segment 31X3 are connected by a second column segment 31Y2.

The metal back layer 20 shown in FIG. 3 is basically composed of S-shaped pattern divisional electrodes 31-1, 31-2, . . . . In this case, the divisional electrodes 31 are arranged such that every two neighboring row segments constitute different divisional electrodes 31. For example, the third row segment 31X3 of the first divisional electrode 31-1 neighbors a first row segment 31X1 and a second row segment 31X2 of a second divisional electrode 31-2. In other words, one row segment (e.g. third row segment 31X3) of the first divisional electrode 31-1 is disposed between two row segments (e.g. first row segment 31X1 and second row segment 31X2) of the second divisional electrode 31-2.

If attention is paid to a divisional electrode 41 shown in FIG. 3, the divisional electrode 41 has a U-shaped pattern in which one-side end portions 42 of a first row segment 41X1 and a second row segment 41X2 are connected by a first column segment 41Y1. Specifically, the metal back layer 20 shown in FIG. 3 is configured by combining the S-shaped pattern divisional electrodes 31 and U-shaped pattern divisional electrodes 41 so that every two neighboring row segments constitute different divisional electrodes.

A common electrode (not shown), which is connected to a high voltage supply section, is provided on an outside of the image display region. Each divisional electrode 30 is connected to the common electrode via a connection resistor (not shown).

In the above-described structure, every two neighboring row segments constitute different divisional electrodes 31. Thus, even if discharge occurs, a discharge voltage at respective row segments has such a distribution that crests and troughs alternately occur with respect to row segments that are points of discharge.

For example, when discharge occurs with a point of discharge at the third row segment 31X3 of the first divisional electrode 31-1, the voltage at the first divisional electrode 31-1 is about 0 V. Specifically, the potential at all the row segments 31X1, 31X2 and 31X3 of the first divisional electrode 31-1 is about 0 V.

On the other hand, the second divisional electrode 31-2 is set at a potential that is higher than the potential of the first divisional electrode 31-1 by several kV. Thus, the third row segment 31X3 of the first divisional electrode 31-1 having the potential of about 0 V is surrounded by the first row segment 31X1 and second row segment 31X2 of the second divisional electrode 31-2 having the potential of several kV. Thereby, the crests and troughs of the potential alternately occur, and a voltage Vc, which is generated between the divisional electrodes, is reduced.

Since the discharge between the divisional electrodes, which is a factor of the increase in discharge current, can be suppressed, the discharge current can be reduced, compared to the prior-art structure, and the discharge damage suppression effect can be enhanced.

Thereby, an image display device with improved reliability can be obtained. At the same time, the anode voltage can be increased and the gap between the front substrate and back substrate can be decreased. Thus, an image display device with improved display characteristics, such as luminance and resolution, can be obtained.

Next, a second embodiment is described. The structural parts common to those of the above-described first embodiment are denoted by like reference numerals, and a detailed description is omitted.

In the second embodiment, like the first embodiment, the metal back layer 20, which is superposed on the phosphor screen 15, is composed of a plurality of insular divisional electrodes 30. Each of the divisional electrodes 30 comprises at least two row segments extending in the row direction X, and column segments which extend in the column direction Y and connect end portions of these row segments.

Specifically, if attention is paid to a first divisional electrode 31-1 shown in FIG. 5, the first divisional electrode 31-1 has a comb-shaped pattern in which one-side end portions 32 of a first row segment 31X1, a second row segment 31X2 and a third row segment 31X3 are connected by a first column segment 31Y1. A second divisional electrode 31-2 has a comb-shaped pattern in which the other-side end portions 33 of a first row segment 31X1, a second row segment 31X2 and a third row segment 31X3 are connected by a second column segment 31Y2. Specifically, the first divisional electrode 31-1 and second divisional electrode 31-2 have symmetric patterns with respect to a central axis extending in the column direction Y.

The metal back layer 20 shown in FIG. 5 is basically composed of comb-shaped pattern divisional electrodes 31-1, 31-2, . . . . In this case, the divisional electrodes 31 are arranged such that every two neighboring row segments constitute different divisional electrodes 31. For example, the third row segment 31X3 of the first divisional electrode 31-1 neighbors the first row segment 31X1 and second row segment 31X2 of the second divisional electrode 31-2. In other words, one row segment (e.g. third row segment 31X3) of the first divisional electrode 31-1 is disposed between two row segments (e.g. first row segment 31X1 and second row segment 31X2) of the second divisional electrode 31-2.

If attention is paid to a divisional electrode 41 shown in FIG. 5, the divisional electrode 41 has a U-shaped pattern in which the other-side end portions 43 of a first row segment 41X1 and a second row segment 41X2 are connected by a second column segment 41Y2. Specifically, the metal back layer 20 shown in FIG. 5 is configured by combining the comb-shaped pattern divisional electrodes 31 and U-shaped pattern divisional electrodes 41 so that every two neighboring row segments constitute different divisional electrodes.

With the second embodiment having the above-described structure, the same advantageous effect as with the first embodiment can be obtained. As regards the comb-shaped pattern divisional electrodes 31 in the second embodiment, the relationship between crests and troughs of potential is similar to that of the S-shaped pattern divisional electrodes in the first embodiment. Unlike the S-shaped pattern divisional electrode, the number of row segments of the comb-shaped pattern divisional electrode can be increased. However, as the number of row segments increases, the capacitance between the row segments and the back substrate 12 increases and the magnitude of discharge may possibly increase. It is thus necessary to set the number of row segments at a proper value. The number of row segments, with which a maximum suppression effect is obtained, is three. The selection between the S-shaped pattern divisional electrode in the first embodiment and the comb-shaped pattern divisional electrode in the second embodiment may be determined in consideration of other design items (e.g. method of connection to the common electrode). If the connection to the common electrode is considered, the S-shaped pattern divisional electrode is preferable since the S-shaped pattern divisional electrode can easily be connected to the common electrode.

Next, a third embodiment is described. The structural parts common to those of the above-described first embodiment are denoted by like reference numerals, and a detailed description is omitted.

In the third embodiment, like the first embodiment, the metal back layer 20, which is superposed on the phosphor screen 15, is composed of a plurality of insular divisional electrodes 30. Each of the divisional electrodes 30 comprises at least two row segments extending in the row direction X, and column segments which extend in the column direction Y and connect end portions of these row segments.

Specifically, if attention is paid to a first divisional electrode 31-1 shown in FIG. 6, the first divisional electrode 31-1 has a U-shaped pattern in which one-side end portions 32 of a first row segment 3lX1 and a second row segment 31X2 are connected by a first column segment 31Y1. In addition, a second divisional electrode 31-2 has a U-shaped pattern in which the other-side end portions 33 of a first row segment 31X1 and a second row segment 31X2 are connected by a second column segment 31Y2. Specifically, the first divisional electrode 31-1 and second divisional electrode 31-2 have symmetric patterns with respect to a central axis extending in the column direction Y. A third divisional electrode 31-3 has the same pattern as the first divisional electrode 31-1, and a fourth divisional electrode 31-4 has the same pattern as the second divisional electrode 31-2.

The metal back layer 20 shown in FIG. 6 is basically composed of U-shaped pattern divisional electrodes 31-1, 31-2, . . . . In this case, the divisional electrodes 31 are arranged such that every two neighboring row segments constitute different divisional electrodes 31. For example, the second row segment 31X2 of the first divisional electrode 31-1 neighbors the first row segment 31X1 of the second divisional electrode 31-2 and the first row segment 31X1 of the third divisional electrode 31-3. In other words, one row segment (e.g. second row segment 31X2) of the first divisional electrode 31-1 and one row segment (e.g. first row segment 31X1) of the third divisional electrode 31-3 are disposed between two row segments (e.g. first row segment 31X1 and second row segment 31X2) of the second divisional electrode 31-2.

With the third embodiment having the above-described structure, the same advantageous effect as with the first embodiment can be obtained.

The length of the S-shaped pattern divisional electrode of the first embodiment or the length of the comb-shaped pattern divisional electrode of the second embodiment is three times greater than the length of a simple single row segment, and accordingly the electrostatic capacitance is also three times greater. On the other hand, if the U-shaped pattern divisional electrode, as described in connection with the third embodiment, is used, the electrostatic capacitance can be suppressed to about double the electrostatic capacitance of the single row segment, while the same potential-reducing effect as with the S-shaped pattern divisional electrode can be obtained.

Thereby, the discharge current can be suppressed and the reliability can be enhanced.

As has been described above, according to the image display device of the embodiment, when discharge occurs between the front substrate and back substrate, the discharge voltage occurring at the divisional electrodes can be reduced (i.e. the potential difference between neighboring row segments can be reduced and the potential gradient at the row segments can be made gentle). Thereby, it becomes possible to suppress discharge between the divisional electrodes, reduce the discharge current, suppress damage due to discharge, and enhance the reliability.

Since the anode voltage can be increased and the gap between the front substrate and back substrate can be decreased, it becomes possible to improve display performance such as luminance and resolution. In addition, since the anode voltage can be increased, the degradation of the phosphor layers can be relaxed and the lifetime of the product can be increased. Furthermore, since it is not necessary to form an additional resistance layer, this invention is advantageous in cost and mass-productivity.

The present invention is not limited to the above-described embodiment. At the stage of practicing the invention, various embodiments may be made by modifying the structural elements without departing from the spirit of the invention. Structural elements disclosed in the embodiment may properly be combined, and various inventions may be made. For example, some structural elements may be omitted from the embodiment. Moreover, structural elements in different embodiments may properly be combined.

In the image display device having the above-described structure, the metal back layer is composed of a plurality of divisional electrodes having special patterns. Thus, the voltage occurring between the divisional electrodes can be suppressed, and the discharge current can be reduced, compared to the prior-art structure.

Therefore, the image display device with high discharge damage suppression effect and high reliability can be provided. Since the anode voltage can be increased and the gap between the front substrate and back substrate can be decreased, the image display device having the improved display performance, such as luminance and resolution, can be obtained. If the anode voltage is increased, the current amount of electron beams can be reduced. Thus, the degradation of phosphors can be relaxed and the lifetime of the product can be increased.

What is claimed is:

1. An image display device comprising:
a front substrate having a phosphor screen which includes a phosphor layer and a light-blocking layer, and a metal back layer which is laid over the phosphor screen and is composed of a plurality of insular divisional electrodes; and
a back substrate which is disposed to be opposed to the front substrate and is provided with electron emitter elements which emit electrons toward the phosphor screen,
wherein the divisional electrode is composed of at least two row segments extending in a row direction, and column segments which extend in a column direction and connect end portions of the row segments.

2. The image display device according to claim 1, wherein every two neighboring row segments constitute different divisional electrodes.

3. The image display device according to claim 1, wherein the divisional electrode has a U-shaped pattern in which one-side end portions of a first row segment and a second row segment are connected by a first column segment.

4. The image display device according to claim 1, wherein the divisional electrode has an S-shaped pattern in which one-side end portions of a first row segment and a second row segment are connected by a first column segment, and the other-side end portions of the second row segment and a third row segment are connected by a second column segment.

5. The image display device according to claim 1, wherein the divisional electrode has a comb-shaped pattern in which one-side end portions of a first row segment, a second row segment and a third row segment are connected by a first column segment.

6. The image display device according to claim 1, wherein one row segment of a first divisional electrode is disposed between two row segments of a second divisional electrode.

7. The image display device according to claim 1, wherein one row segment of a first divisional electrode and one row segment of a second divisional electrode are disposed between two row segments of a third divisional electrode.

8. The image display device according to claim 1, wherein the row segments of the divisional electrode are disposed on the phosphor layer of the phosphor screen.

9. The image display device according to claim 1, wherein the metal back layer is configured by combining at least two kinds of a divisional electrode having a U-shaped pattern in which one-side end portions of a first row segment and a second row segment are connected by a first column segment, a divisional electrode having an S-shaped pattern in which one-side end portions of a first row segment and a second row segment are connected by a first column segment and the other-side end portions of the second row segment and a third row segment are connected by a second column segment, and a divisional electrode having a comb-shaped pattern in which one-side end portions of a first row segment, a second row segment and a third row segment are connected by a first column segment.
